(19) United States
(12) Patent Application Publication
(10) Pub. No.: US 2005/0254913 A1
(43) Pub. Date: Nov. 17, 2005

(54) Device for machining grooves in a cylindrical bore, in particular of a brake master cylinder

(75) Inventor: Tomas Leon, Montigala-Badalona (ES)

Correspondence Address: LEO H MCCORMICK, 2112 MISHAWAKA AVE, P O BOX 4721, SOUTH BEND, IN, 46634, US

(73) Assignee: Robert Bosch GmbH

(21) Appl. No.: 11/099,858

(22) Filed: Apr. 6, 2005

(30) Foreign Application Priority Data
Apr. 29, 2004 (FR) 04 04612

(51) Int. Cl. B23C 3/34

(52) U.S. Cl. 409/200

(57) ABSTRACT

A device for machining grooves (20) in a cylindrical bore emerging at the end of a master cylinder. The device includes a cylindrical tool (44) with a peripheral set of teeth (45) formed thereon by a series of cutting teeth (46). The tool (44) is inserted axially in the bore of the master cylinder (1) through a tool-holder shaft (39) that is initially driven in an orbital movement and later held immobile in rotation about its axis (42) and the master cylinder 1) and the tool-holder shaft (39) are thereafter separated from each other by axial translation.

The present invention relates to a device for machining grooves in a cylindrical bore, in particular of a brake master cylinder for a motor vehicle.

In present day technology, a brake master cylinder, such as a tandem master-cylinder, comprises a body formed with an axial bore comprising cylinder walls for guiding a primary piston and a secondary piston, these cylinder walls being adjacent to housings for seals which are fitted in the body of the master cylinder and which cooperate with the primary and secondary pistons. Grooves for the passage of brake fluid are formed in the cylinder walls to allow the return of the brake fluid to the reservoir which feeds the master cylinder, when the brake pedal is released.

The seals fitted in the vicinity of the cylinder walls are subjected to the pressure forces of the brake fluid and have a tendency to extrude into the grooves of the cylinder walls. The presence of micro-burrs or of micro-welds at the ends of the grooves is furthermore capable of causing faster deterioration of the seals.

The machining devises currently used for producing these grooves are not satisfactory and do not make it possible to machine the grooves quickly with sufficient precision. Neither are they capable of machining, in the cylinder walls, helical grooves which damage the seals less than straight grooves parallel with the axis of the bore do, as has been observed in practice.

The purpose of the present invention is, in particular, to solve the problem of machining these grooves in a simple, reliable and economic manner.

For this purpose it proposes a device for machining grooves in a cylindrical bore emerging at the end of a workpiece, characterized in that it comprises:
a cylindrical tool with a peripheral set of teeth formed by a series of cutting teeth which extend obliquely with respect to the axis of the tool, this tool being designed to be inserted axially in the bore of the workpiece,
a tool-holder shaft, at one end of which the tool is fixed in such a way as to extend in the axial extension of the shaft,
means of driving the shaft in an orbital movement about a fixed axis which intersects the axis of the shaft and of the tool at a point situated at a forward end of the set of teeth of the tool,
means of immobilizing the shaft in rotation about its axis,
and means of relative displacement in axial translation of the workpiece comprising the bore and of the tool-holder shaft.

This device has a number of important advantages:
it makes it possible to machine simultaneously all of the grooves of a cylinder wall;
due to the orbital movement of the tool, a small number of teeth work simultaneously in machining, which reduces the heating up of the tool and the machining force and increases the machining precision;
the orbital movement of the tool combined with the relative axial displacement between the tool and the workpiece makes it possible to machine shallow grooves of relatively long length;
the obliqueness of the teeth of the tool makes it possible to machine relatively wide grooves using a low amplitude of orbital movement.

According to another feature of the invention, the means of driving the shaft in orbital motion comprise a cylindrical component whose axis is the said fixed axis, means of mounting this component in rotation about its axis on a fixed support, means of mounting the tool-holder shaft in rotation about its axis in a cylindrical orifice that is eccentric with respect to the said component, and means of driving the component in rotation about the said fixed axis.

In a preferred embodiment of the invention, the said cylindrical component is a long cylindrical socket which is supported and guided in rotation at its ends by external bearings carried by the fixed support, and which comprises a cylindrical housing in which the tool-holder shaft is supported and guided in rotation by means of bearings.

This configuration makes it possible to obtain a very accurate guidance of the orbital movement of the tool-holder shaft, which significantly improves the machining precision of the grooves.

Advantageously, the means of immobilization in rotation of the tool-holder shaft comprise a double universal joint connecting to a fixed support the end of the shaft that is opposite to the one carrying the tool.

These means of immobilization in rotation are very reliable, inexpensive and not very subject to wear. They immobilize the tool-holder shaft in rotation in a positive manner without inhibiting its orbital movement.

According to another feature of the invention, the device comprises means of driving the workpiece in rotation about the axis of the bore, for the formation of helical grooves in the internal cylindrical surface of the bore.

This makes it possible to machine helical grooves simply and accurately.

The device according to the invention is advantageously used for machining helical grooves for the passage of fluid in internal cylinder walls of a brake master cylinder for a motor vehicle.

The invention also relates to a brake master cylinder for a motor vehicle, comprising internal cylinder walls for guiding at least one piston, which are formed with grooves for the passage of brake fluid, characterized in that the said grooves are machined by means of the said device.

Other advantages and features of the invention will appear on reading the following description given by way of non-limiting example and with reference to the appended drawings in which:

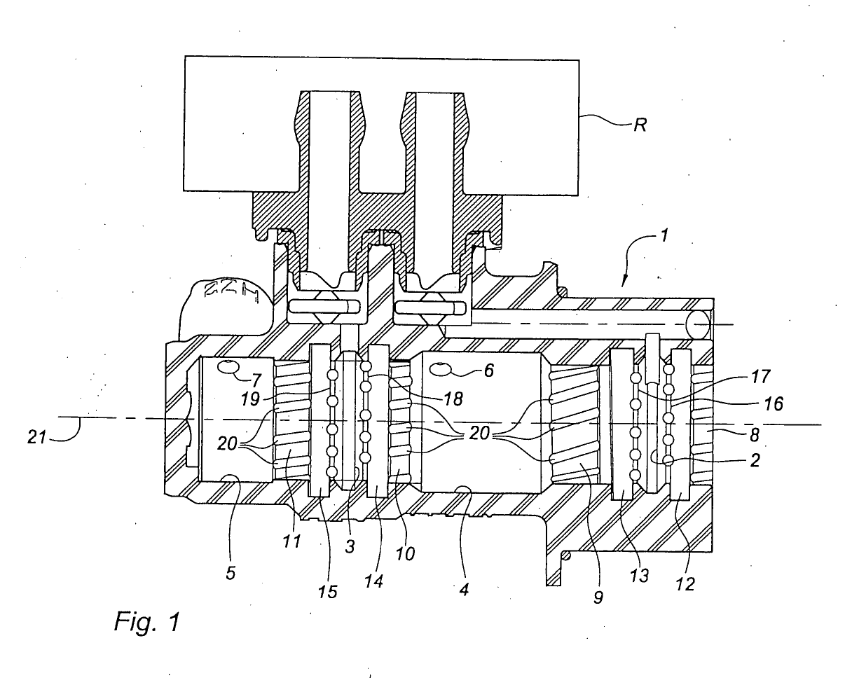

FIG. 1 is an axial cross-sectional view of a master cylinder comprising cylinder walls formed with grooves for the passage of brake fluid;

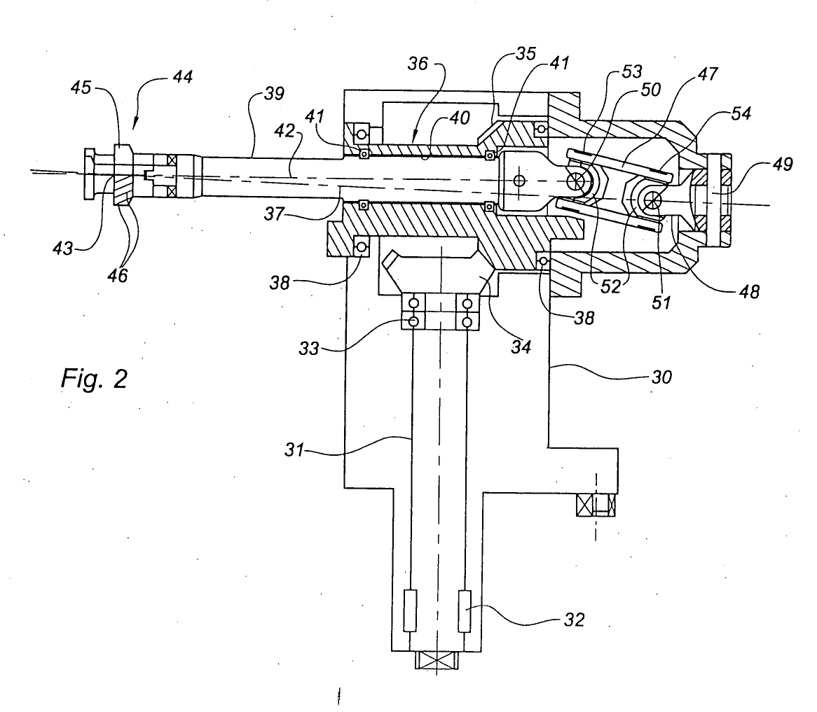

FIG. 2 is a diagrammatic cross-sectional view of the machining device according to the invention;

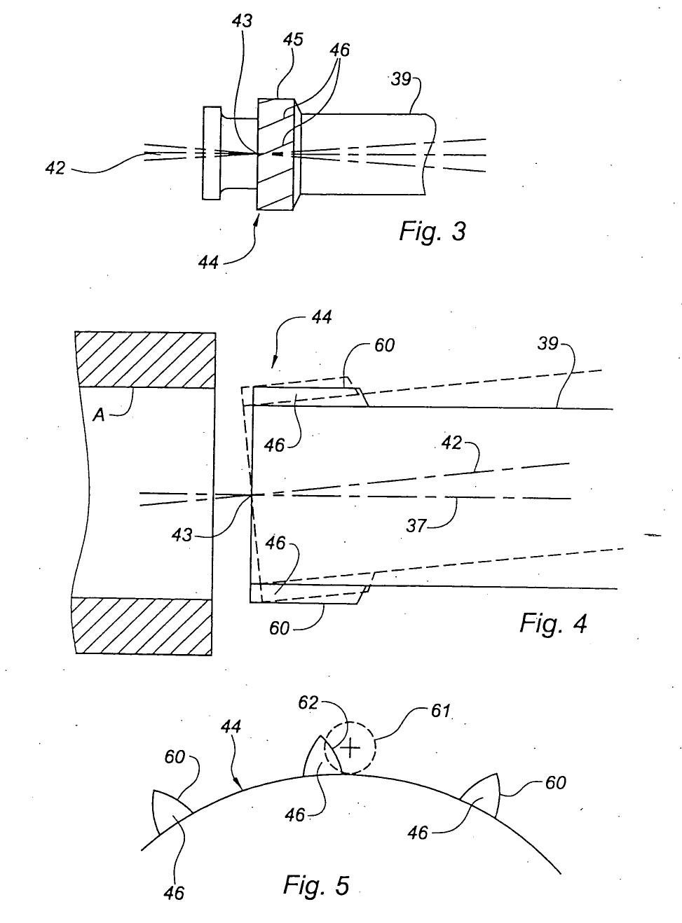

FIG. 3 is an enlarged diagrammatic view of the tool shown in FIG. 2;

FIG. 4 is a diagrammatic illustration of the functioning of the tool during a machining operation;

FIG. 5 is a diagrammatic straight end view, at a larger scale, of a part of the set of cutting teeth of the tool shown diagrammatically in FIG. 4.

In FIG. 1, the reference 1 refers to a tandem master cylinder of a braking device for a motor vehicle, which comprises two feed chambers 2, 3 connected to a reservoir R of brake fluid. Each chamber 2, 3 feeds hydraulic fluid to a working chamber 4, 5 which respectively feed a braking circuit with pressurized brake fluid through an orifice 6, 7.

A primary piston (not shown) is housed in the working chamber 4 to control the pressure of the fluid in a first braking circuit and a secondary piston (not shown) is housed in the secondary working chamber 5 to control the pressure of the fluid in a second braking circuit.

Cylinder walls 8, 9, 10, 11 are formed on the internal surface of the body of the master cylinder 1 for guiding the primary and secondary pistons and are adjacent to annular housings 12, 13, 14, 15 receiving seals (not shown) and in which the pistons can slide in a fluid-tight manner during a braking operation.

Other cylinder walls 16, 17, 18, 19 of short axial length are formed on either side of the feed chambers 2, 3 between the latter and the annular housings 12, 13, 14, 15 of the seals.

Grooves 20, preferably helical with respect to the axis 21 of the master cylinder 1, are formed in the cylinder walls 8 to 11 and 16 to 19 to allow the return of the brake fluid to the reservoir R through the chambers 2, 3 at the end of a braking operation, when the driver releases the force that he is applying to the brake pedal.

These grooves are machined in the cylinder walls of the master cylinder by means of a device which will now be described with reference to FIG. 2 and the following figures.

This device comprises a fixed chassis or frame 30 on which is mounted an electric motor (not shown) for driving in rotation a shaft 31 which extends vertically in the view shown in FIG. 2 and which is centered and guided in rotation by bearings 32, 33 mounted on the chassis 30. At its free end, the shaft 31 is integral with a conical pinion 34 which engages with a conical set of teeth 35 of a long cylindrical socket 36 which extends perpendicular to the shaft 31 and which is supported and guided in rotation about its axis 37 by bearings 38 mounted in the chassis 30.

The socket 36 is traversed by a tool-holder shaft -39 which is received in a cylindrical housing 40 of the socket and which is guided in rotation in this housing by bearings 41, the common axis 42 of the housing 40 and of the shaft 39 being inclined with respect to the axis 37 of the socket and intersecting the latter at a point 43 situated at the forward end of the shaft 39.

This forward end carries a cutting tool 44, fixed to the shaft 39 by any appropriate means such as a screw, the tool 44 comprising a peripheral set of teeth 45, the individual teeth 46 of which extend obliquely with respect to the axis of the tool, which coincides with the axis 42 of the shaft 39.

Means of adjusting the longitudinal position of the tool 44 on the shaft are provided in order to place the forward end of the set of teeth 45 at the point of intersection 43 of the axes 37 and 42.

The rear end of the shaft 39 is connected to the chassis 30 by means of immobilization in rotation, preventing the shaft 39 from rotating about its axis 42, but allowing its orbital movement about the axis 37 of the socket 36 as described in detail below.

In FIG. 2, the means of immobilization in rotation are formed by a double universal joint, comprising a double stirrup 47 mounted between the end of the shaft 39 and a part 48 articulated on the chassis 30 about an axis 49 parallel with the shaft 31.

The stirrup 47 is articulated on the end of the shaft 39 about an axis 50, perpendicular to the axis 49 and to the axis 42 of the shaft 39, and is articulated on the part 48 about an axis 51 perpendicular to the axis 49 and to the axis 42.

The connections of the stirrup 47 onto the part 48 and onto the shaft 39 are provided by yokes 52 mounted in an articulated manner on the stirrup about two parallel axes 53, 54 contained in the plane of the drawing, one of them carrying the axis of articulation 50 on the shaft 39 and the other the axis of articulation 51 on the part 48.

The tool 46 can be seen better in the enlarged view shown in FIG. 3. The individual cutting teeth 46 are oriented obliquely over an annular section of the end of the tool holder shaft 39 and the set of teeth 45 is of generally cylindrical or truncated cone shape, its outer diameter being for example bigger at its forward end than at its rear end, with a slight angle with respect to the axis of the tool 44.

The individual teeth 46 are twelve in number in this case, the number of individual teeth 46 corresponding to the number of grooves to be machined in a cylinder wall.

The functioning of this device is as follows:

The shaft 31 is driven in rotation by the electric motor and drives the socket 36 in rotation about its axis 37 at a speed of between 2500 and about 5000 revolutions per minute.

The rotation of the socket 36 causes an orbital movement of the tool-holder shaft 39 about the axis 37 of the socket 36, each point of the shaft 39 describing a circle centered on an axis parallel with the axis 37 and whose radius depends on the distance between this point and the point 43 of intersection of the axes 37 and 42 where the amplitude of the orbital movement is zero, and on the distance from this point to the axis 42 of the tool-holder shaft 39.

The rotation of the shaft 39 about its axis 42 is prevented by the double universal joint 47, 48 connecting the rear end of the shaft 39 to the chassis 30. This immobilization in rotation about the axis 42 however causes a slight axial displacement of the shaft 39 (which is of the order of 0.6 millimeters in one example of embodiment).

The set of teeth 45 of the tool 44 has an external diameter at its forward end which is substantially equal to the internal diameter of the bore A (or of the cylinder wall) in which it has to machine the grooves.

The orbital movement of the cutting edges 60 of the individual teeth 46 about the axis 37 of the socket 36 takes place at a speed of rotation which is equal to the speed of rotation of the socket 36. This movement is represented in FIG. 4 where a median position of the tool 44 is shown in full line and another position is shown in dotted lines, this other position corresponding to a maximum inclination (in the plane of the drawing) of the set of teeth 45 in one direction with respect to the axis 37.

The orbital movement of the tool 44 therefore causes each cutting edge 60 to oscillate about the position shown in full line in FIG. 4. This oscillation is combined with a relative axial displacement between the tool 44 and the workpiece to be machined which causes the tool 44 to penetrate progressively into the bore A.

The speed of axial translation of the workpiece with respect to the tool 44 is for example between 750 and about 1200 millimeters per second. During this axial displacement, each cutting edge 60 progressively machines, in the internal cylindrical surface of the bore A, a groove whose length corresponds to the axial displacement of the cutting edge 60, whose width is defined by the obliqueness of the cutting edge 60 and by the amplitude of the orbital movement, and whose depth is defined by the amplitude of that orbital movement.

In order to give a better understanding of the way in which this machining is carried out, a trajectory 61 described by a point 62 of a cutting edge 60 has been shown in dotted line in FIG. 5.

During the orbital movement of the set of teeth 45, only three teeth 46 out of twelve are simultaneously in contact at each instant with the material of the workpiece to be machined, and the twelve grooves are successively machined on each revolution of the set of teeth 45 about the axis 37.

If the workpiece is made to rotate about the axis 37 during its axial translation, the grooves are machined as a helix with respect to the axis of the bore A, the angle of the helix with respect to the axis of the bore A being equal to the angle of rotation of the workpiece about this axis and, for example, being about 200 in one example of embodiment.

The device according to the invention allows the machining of helical grooves inside a bore, in particular that of a master cylinder, without damaging the edges of the housings of the seals, which would cause their premature deterioration.

It also has the advantage of using a small number of cutting teeth simultaneously in machining, which reduces the machining force (for example by 75% when three teeth out of twelve are working simultaneously) and also improves the lubrication of the cutting face of the tool, which prevents the formation of micro-welds on the cutting edges. The reduction in machining force also makes it possible to increase the speed of advance of the tool, which increases for example from 100 to 750/1200 millimeters per minute.

1. A device for machining grooves (20) in a cylindrical bore emerging at the end of a workpiece (1), characterized in that i said device comprises:
a cylindrical tool (44) with a peripheral set of teeth (45) formed by a series of cutting teeth (46) which extend obliquely with respect to the axis (42) of the tool, said tool (44) being inserted axially in the bore of the workpiece (1);
a tool-holder shaft (39), at one end of which the tool (44) is fixed in such a way as to extend in the axial extension of the shaft (39);
first means of driving the shaft (39) in an orbital movement about a fixed axis (37) which intersects the axis (42) of the shaft (39) and of the tool (44) at a point (43) situated at a forward end of the set of teeth (45) of the tool (44);
second means (47, 48) of immobilizing the shaft (39) in rotation about its axis (42);and
third means of relative displacement in axial translation of the workpiece (1) and of the tool-holder shaft (39).

2. The device according to claim 1, characterized in that the first means of driving the shaft (39) in orbital motion comprise a cylindrical component (36) whose axis is the said fixed axis (37) includes fourth means (38) of mounting this component in rotation about its axis (37) on a fixed support (30), and fifth means (41) of mounting the tool-holder shaft (39) in rotation about its axis (42) in a cylindrical orifice (40) that is eccentric with respect to the said component (36), and means (31, 34) of driving the component (36) in rotation about the said fixed axis (37).

3. The device according to claim 2, characterized in that the said cylindrical component is a long cylindrical socket (36) which is supported and guided in rotation at its ends by external bearings (38) carried by the fixed support (30), and which comprises a cylindrical housing (40) in which the tool-holder shaft (39) is supported and guided in rotation by fifth means of bearings (41).

4. The device according to claim 3, characterized in that one end of the socket (36) comprises an external set of teeth (35) engaged with a drive pinion (34).

5. The device according to claim 4, characterized in that the second means of immobilization (46, 47) in rotation of the tool-holder shaft comprise a double universal joint connecting to a fixed support (30) the end of the shaft (39) that is opposite to the one carrying the tool (44).

6. The device according to claim 5, characterized in that [it] said workpiece (1) is rotated about the axis (21) of the bore, for the formation of helical grooves (20) in the internal cylindrical surface (64) of the bore.

7. The device according to claim 6, characterized in that the external radius of the peripheral set of teeth (45) of the tool (44) is substantially equal to the internal radius of the bore.

8. The device according to claim 7, characterized in that the peripheral set of teeth (45) of the tool (44) is of generally truncated cone or cylindrical shape.

9. The device according to claim 8, characterized in that the number of teeth (46) of the tool is equal to the number of grooves (20) to be machined.

10. The device according to claim 9, characterized in that the speed of rotation of the first means of driving the shaft (39) in orbital movement is between 2500 and about 5000 revolutions per minute.

11. The device according to claim 9, characterized in that the relative speed of axial translation of the workpiece (1) with respect to the tool (44) is between 750 and about 1200 millimeters per minute.

12. The device according to claim 5 for machining grooves (20) for a passage of brake fluid in internal cylinder walls (8, 9, 10, 11) of a brake master cylinder [(1)] for a motor vehicle.

13. (canceled)

14. (canceled)
